(19) United States
(12) Patent Application Publication
(10) Pub. No.: US 2005/0219601 A1
(43) Pub. Date: Oct. 6, 2005

(54) Image recording system and relay apparatus

(75) Inventors: Akira Tamagaki, Nara-shi (JP); Akihiko Taniguchi, Yamatokoriyama-shi (JP); Junichi Kajiwara, Nara-shi (JP); Takao Horiuchi, Nara-shi (JP); Yoshiomi Hamano, Yamatokoriyama-shi (JP); Kiyoshi Inoue, Nara-shi (JP); Hiroki Kai, Yamatokoriyama-shi (JP); Koichi Sumida, Tenri-shi (JP); Yohichi Shimazawa, Nara-shi (JP)

Correspondence Address: EDWARDS & ANGELL, LLP, P.O. BOX 55874, BOSTON, MA, 02205, US

(73) Assignee: Sharp Kabushiki Kaisha

(21) Appl. No.: 11/002,705

(22) Filed: Dec. 1, 2004

(30) Foreign Application Priority Data
Dec. 5, 2003 (JP) 2003-408036

(51) Int. Cl. G06F 15/00; G06K 9/00

(52) U.S. Cl. 358/1.14

(57) ABSTRACT

A relay apparatus (relay unit) is provided between a PC, from which image data is transmitted, and an image recording apparatus (image recording unit). The relay apparatus executes a process for correcting a color on the image data transmitted from the PC to the image recording apparatus. In addition, a storage unit of the relay apparatus stores unique information of the image recording apparatus, such as a production number. The relay apparatus executes processes for correcting the image data and for adding the unique information to the image data transmitted from the PC, and then transmits the processed image data to the image recording apparatus. Thus, realized is an image recording system and the relay apparatus, in which it is not necessary to provide a circuit which executes a process for embedding unique information in the image data in the image recording apparatus, so that deterioration in quality of the image caused by the unique information can be prevented as much as possible.

### CROSS-REFERENCE TO RELATED APPLICATION

This nonprovisional application claims priority under 35 U.S.C. §119(a) on Patent Application No. 2003-408036 filed in Japan on Dec. 5, 2003, the entire contents of which are hereby incorporated by reference.

### BACKGROUND OF THE INVENTION

1. Field of the Invention

The present invention relates to an image recording system including an image recording unit which records images based on image data and a relay unit which relays the image data to the image recording unit, and a relay apparatus.

2. Description of the Related Art

As image processing technology has been developed, an image can be reproduced faithfully by scanning an image recorded on paper by a scanner to take in the image as image data, forming an image from the image data and recording it on a recording paper in an image recording apparatus. In addition, as image quality of color printing is improved, a full-color image of high quality can be easily formed. Furthermore, as a software for image processing which can be used in an information processing apparatus such as a personal computer (PC) has been widely spread, an image desired by a user can be easily made by forming image data in the information processing apparatus through a process for adjusting a color and the like, and transmitting the image data to the image recording apparatus to record the image.

Thus, since the present image recording apparatus can form an elaborate image by using the image processing technology, it comprises a function of prohibiting illegal usage such as duplication of paper money or valuable stock certificates. As an example of such function, there is a function of adding information unique to the image recording apparatus (referred to as the unique information hereinafter) such as a name of manufacturer and a production number, to a recorded matter of the image outputted from the image recording apparatus. For example, by adding a predetermined pattern to a color image with ink having a color which is not likely to be visually observed, the unique information can be added inconspicuously. Thus, the image recording apparatus which outputted the recorded matter can be specified from the unique information added to the recorded matter of the image.

Meanwhile, there is a case where an image is recorded with a color which is different from the color desired by the user when the image data formed by the software for the image processing in the information processing apparatus such as the PC is recorded as the image in the imager recording apparatus. This is because a method of expressing a color by the display such as a CRT display is different from a method of expressing a color by the image recording apparatus based on the image data. Thus, there is practically used an image recording system in which a relay apparatus which relays image data is provided between an information processing apparatus and an image recording apparatus so as to correct the image data transmitted from the information processing apparatus such that a color of an image displayed in the information processing apparatus may approximate to a color of an image recorded by the image recording apparatus as much as possible, and the image recording apparatus records an image based on the corrected image data.

The above image recording system is disclosed in Japanese Patent Application Laid-Open Nos. 2001-69335, Japanese Patent Application Laid-Open No. 2001-309156, Japanese Patent Application Laid-Open No. 2000-246997, and the like.

Meanwhile, in order to implement the function of adding the unique information to the image outputted from the image recording apparatus, it is necessary to provide a circuit which executes a process for embedding the unique information into the image data. However, there is a problem such that the cost of the image recording apparatus is increased for that. In addition, when the image data is corrected by the relay apparatus, the quality of the corrected image deteriorates because the unique information is embedded in the image data in the image recording apparatus.

### BRIEF SUMMARY OF THE INVENTION

The present invention has been made in view of the above circumstances, and it is an object of the present invention to provide an image recording system in which a relay unit is provided between an image recording unit which records images and an information processing apparatus which transmits image data and, when the relay unit corrects the image data while embedding information unique to the image recording unit in the image data, it is not necessary to provide a circuit, which executes a process for embedding the unique information in the image data, in the image recording unit and deterioration of image quality caused by the unique information can be prevented as much as possible, and a relay apparatus serving as the relay unit constituting the image recording system.

An image recording system according to the present invention is an image recording system including: an image recording unit for recording images based on image data; and a relay unit for relaying image data to be transmitted to the image recording unit and transmitting the image data to the image recording unit, characterized in that the relay unit comprises: unique information adding means for adding unique information of the image recording unit to the image data to be transmitted to the image recording unit; and transmitting means for transmitting the image data to which the unique information is added by the unique information adding means, to the image recording unit.

The image recording system according to the present invention is characterized in that the relay unit comprises means for limiting an operation of itself when the unique information of the image recording unit cannot be recognized.

The image recording system according to the present invention is the image recording system characterized in that the image recording unit comprises: unique information storing means for storing the unique information; and transmitting means for transmitting the unique information stored in the unique information storing means to the relay unit.

The image recording system according to the present invention is characterized in that the relay unit further comprises storing means for storing the unique information transmitted from the image recording unit.

The image recording system according to the present invention is characterized in that the relay unit further comprises: comparing means for comparing the unique information transmitted from the image recording unit with the unique information already stored in the storing means; and means for limiting an operation of itself based on the comparison result by the comparing means.

The image recording system according to the present invention is characterized in that the relay unit further comprises: comparing means for comparing the unique information transmitted from the image recording unit with the unique information already stored in the storing means; and means for transmitting the comparison result by the comparing means to another predetermined apparatus.

The image recording system according to the present invention is characterized in that the image recording unit further comprises means for determining whether a state of the image recording unit satisfies a predetermined condition or not; and when the means determines that the state of the image recording unit satisfies the predetermined condition, means for making the transmitting means transmit the unique information stored in the unique information storing means to the relay unit.

A relay apparatus according to the present invention which relays image data to an external image recording apparatus for recording an image based on the image data, characterized by comprising: unique information adding means for adding unique information of the image recording apparatus to the image data to be transmitted to the image recording apparatus; and means for transmitting the image data, to which the unique information is added by the unique information adding means, to the image recording apparatus.

The relay apparatus according to the present invention is characterized by further comprising means for limiting an operation of itself when the unique information cannot be recognized.

The relay apparatus according to the present invention is characterized by further comprising: receiving means for receiving the unique information from the image recording unit; and storing means for storing the unique information received by the receiving means.

The relay apparatus according to the present invention is characterized by further comprising: comparing means for comparing the unique information received by the receiving means with the unique information already stored in the storing means; and means for limiting an operation of itself based on the comparison result by the comparing means.

The relay apparatus according to the present invention is characterized by further comprising: comparing means for comparing the unique information received by the receiving means with the unique information already stored in the storing means; and means for transmitting the comparison result by the comparing means to another predetermined apparatus.

According to the present invention, the relay unit (relay apparatus) is provided between the image data source such as a PC and the image recording unit (image recording apparatus), and the relay unit adds the unique information of the image recording unit, such as information showing a name of manufacturer and a production number, to the image data to be transmitted to the image recording unit and transmits the image data, to which the unique information is added, to the image recording unit.

According to the present invention, the relay unit (relay apparatus) limits own operation such as stopping the process when the unique information of the image recording unit (image recording apparatus) cannot be recognized, that is, when the unique information has not stored yet, for example.

According to the present invention, the image recording unit stores the unique information and transmits the unique information to the relay unit.

According to the present invention, the relay unit (relay apparatus) stores the unique information transmitted from the image recording unit (image recording apparatus).

According to the present invention, the relay unit (relay apparatus) compares the unique information transmitted from the image recording unit (image recording apparatus) with the already stored unique information and, when both the unique information do not coincide with each other, limits own operation such as prohibiting the process based on the comparison result of the unique information.

According to the present invention, the relay unit (relay apparatus) compares the unique information transmitted from the image recording unit (image recording apparatus) with the already stored unique information and transmits the comparison result of both the unique information to another apparatus.

According to the present invention, the image recording unit transmits the unique information to the relay unit when the predetermined condition is satisfied such as when power is applied or the relay unit is confirmed.

According to the present invention as describe above, since the relay unit (relay apparatus) is provided between the image data source such as the PC and the image recording unit (image recording apparatus), and the relay unit adds the unique information of the image recording unit to the image data and transmits the image data to the image recording unit, it is not necessary to provide the circuit which executes the process for embedding the unique information in the image data on the side of the image recording unit, and the cost of the image recording unit can be lowered. In addition, since the relay unit executes both correction of the image data regarding the image color and addition of the unique information, the deterioration in image quality due to the addition of the unique information can be prevented as much as possible.

According to the present invention, since the relay unit (relay apparatus) limits the process, that is, prohibits the process and the like when the unique information of the image recording unit (image recording apparatus) cannot be recognized, such as when the unique information has not been stored yet, the image can be recorded only when the unique information can be added. Therefore, the image recording unit can be more surely specified from the recorded matter of the image, for example.

According to the present invention, by transmitting the unique information from the image recording unit to the relay unit, it is not necessary for the user to set the unique information manually. Thus, the leak of the unique information caused by the manual setting of the unique information will not happen.

According to the present invention, the relay unit (relay apparatus) stores the unique information of the image recording unit (image recording apparatus) and it can surely add the unique information to the image recorded by the image recording unit by executing the process for adding the stored unique information to the image data. Therefore, the image recording unit can be surely specified from the recorded matter of the image by the present invention.

According to the present invention, since the relay unit (relay apparatus) compares the unique information transmitted from the image recording unit (image recording apparatus) with the previously stored unique information and when both the unique information do not coincides with each other, the relay unit (relay apparatus) limits the process, that is, prohibits the process and the like based on the comparison result of both the unique information, the unique information can be prevented from being falsified or forged or illegal usage such as masquerading as the image recording unit can be prevented. Therefore, the image recording unit can be more surely specified from the recorded matter of the image.

According to the present invention, since the relay unit (relay apparatus) informs the manager of the abnormality of the unique information by transmitting the comparison result of both the unique information to the managing apparatus managed by the manager, the illegal usage can be prevented from being continued.

According to the present invention, the image recording unit transmits the unique information to the relay unit when the predetermined condition in which the image can be recorded is satisfied, such as when power is applied or when the relay unit is confirmed. Therefore, since the unique information is not unnecessarily transmitted in a state the image cannot be recorded, the unique information can be prevented from leaking.

The above an further objects and features of the present invention will more fully be apparent from the following detailed description with accompanying drawings.

### BRIEF DESCRIPTION OF THE SEVERAL VIEWS OF THE DRAWINGS

FIG. 1 is a block diagram showing a configuration of an image recording system according to the present invention;

FIG. 2 is a flowchart showing procedures of a process executed by the image recording system of the present invention when an image recording apparatus is turned on; and

FIG. 3 is a flowchart showing procedures of a process executed by a relay apparatus when the image recording system of the present invention records an image.

### DETAILED DESCRIPTION OF THE PREFERRED EMBODIMENTS

Hereinafter, the present invention will be described in detail with reference to the drawings showing its embodiment.

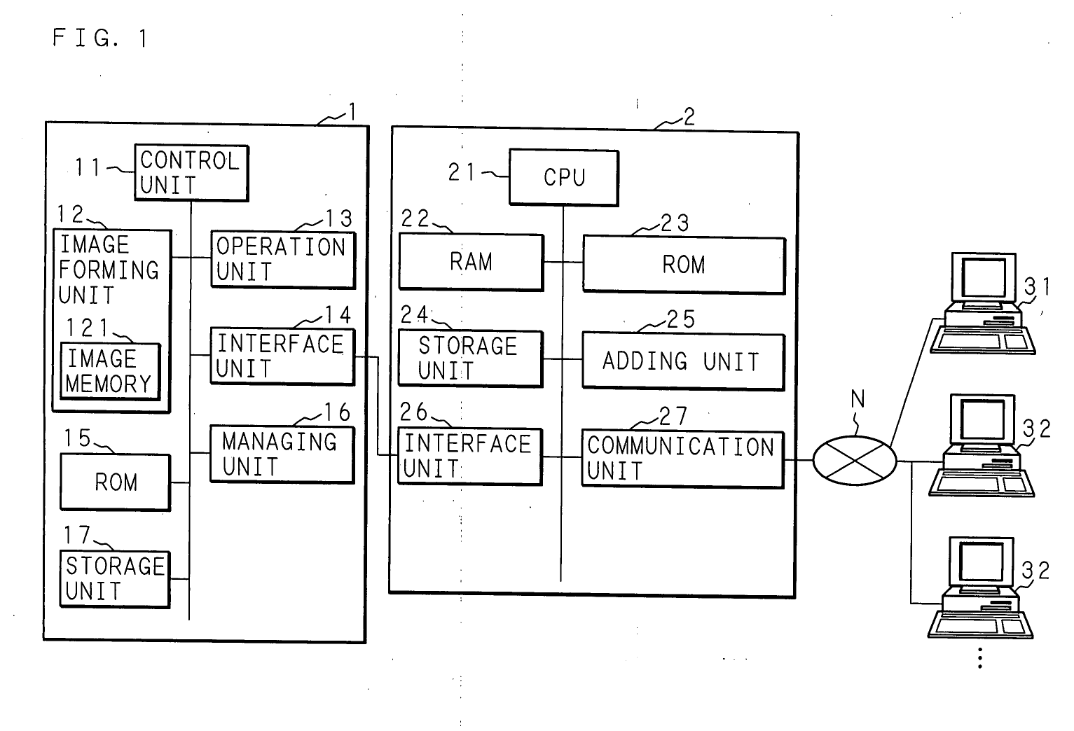

FIG. 1 is a block diagram showing a configuration of an image recording system according to the present invention. Reference numeral 1 designates an image recording apparatus as an image recording unit according to the present invention. A relay apparatus (relay unit) 2 is connected to the image recording apparatus 1. The relay apparatus 2 is connected to a communication network N such as an in-house LAN and the like. Personal computers (PC) 32 and a managing apparatus 31 which is an information processing apparatus used by a manager of the image recording system are connected to the communication network N. The PC 32 transmits image data to the image recording apparatus 1 through the communication network N, and the relay apparatus 2 relays the transmitted image data to the image recording apparatus 1, and the image recording apparatus 1 records images based on the image data.

The image recording apparatus 1 is provided with a control unit 11 comprising a CPU for executing calculations and a RAM for temporally storing information along with the calculation and the like. A ROM 15 for storing a control program to control the image recording apparatus 1 is connected to the control unit 11. The control unit 11 controls the entire image recording apparatus 1 according to the control program stored in the ROM 15. In addition, a managing unit 16 which is a memory to store management information for managing a process executed by the image recording apparatus 1 is connected to the control unit 11. The control unit 11 refers to the management information stored in the managing unit 16 and controls the image recording apparatus 1 based on the referred information. In addition, the managing unit 16 stores unique information which is peculiar to the image recording apparatus 1 such as a name of manufacturer, a production number and the like of the image recording apparatus 1.

Furthermore, an interface unit (transmitting means) 14 which is connected to the relay apparatus 2, a storage unit 17 comprising a hard disk or a nonvolatile memory, and an image forming unit 12 are connected to the control unit 11. The interface unit 14 exchanges data with the relay apparatus 2 and receives the image data from the relay apparatus 2. In addition, the interface unit 14 can transmit the unique information stored in the managing unit 16 to the relay apparatus 2. The storage unit 17 stores the image data received by the interface unit 14. The image forming unit 12 comprises an image memory 121 for temporally storing the image data. The image data stored in the storage unit 17 is read by the image memory 121, and the image forming unit 12 forms an image from the image data stored in the image memory 121, and records the image on a recording paper to output a recorded matter of image. The image recording apparatus 1 functions as a network printer apparatus by receiving the image data transmitted from the PC 32 through the communication network N and the relay apparatus 2 by the interface unit 14, and forming the image from the received image data and recording it by the image forming unit 12.

Furthermore, an operation unit 13 which receives an operation from a user is connected to the control unit 11. The operation unit 13 comprises displaying means such as a liquid crystal panel and the like, which displays information required for the operation, and inputting means such as a touch panel, a numeric keypad and the like, from which information such as a control order is inputted by the operation of the user.

The relay apparatus 2 is an apparatus which expands the image data transmitted from the PC 32 and corrects the image data so that a color of the image displayed in a display apparatus such as a CRT display provided in the PC 32 may approximate to a color of the image recorded in the image recording apparatus 1 as much as possible. The relay apparatus 2 comprises a CPU 21 which executes calculations, a RAM 22 which stores data along with the calculations, and a ROM 23 which stores a control program for controlling the relay apparatus 2. The CPU 21 controls the operation of the relay apparatus 2 according to a control program stored in the ROM 23. In addition, an interface unit 26 connected to the image recording apparatus 1, and a communication unit 27 connected to the communication network N are connected to the CPU 21. The communication unit 27 receives the image data transmitted from the PC 32 through the communication network N, and the RAM 22 stores the received image data. The CPU 21 corrects the image data according to the control program stored in the ROM 23, and the interface unit 26 transmits the corrected image data to the image recording apparatus 1.

In addition, the relay apparatus 2 according to the present invention executes a process for adding the unique information to the image data so that the image recording apparatus 1 can record the image including the unique information of the image recording apparatus 1. Furthermore, a storage unit (storing means) 24 which stores the unique information transmitted from the image recording apparatus 1, and an adding unit 25 which executes the process for adding the unique information to the image data are connected to the CPU 21. The adding unit 25 adds the unique information stored in the storage unit 24 to the image data received by the communication unit 27, and the interface unit 26 transmits to the image recording apparatus 1 the image data to which the unique information is added.

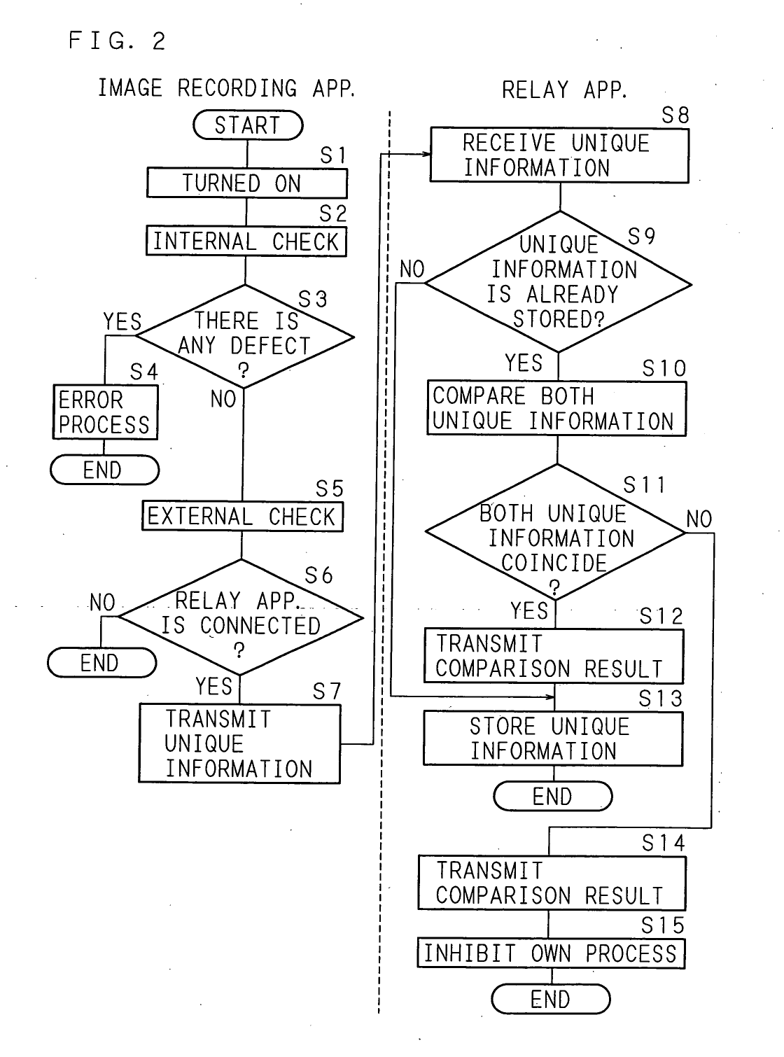

Next, the operation of the image recording apparatus will be described with reference to a flowchart. FIG. 2 is a flowchart showing procedures of the operation executed by the image recording system of the present invention when the image recording apparatus 1 is turned on. When a power supply of the image recording apparatus 1 is turned on by the operation of the user (S1), according to the control program stored in the ROM 15, the control unit 11 of the image recording apparatus 1 executes internal checks whether each unit of the image recording apparatus 1 is normally operated or there is any defect in the information stored in each unit and the like (S2). Then, according to the control program stored in the ROM 15, the control unit 11 determines whether there is any defect in the image recording apparatus 1 or not with reference to a result of the internal checks (S3). When there is a defect (S3: YES), the control unit 11 executes an error process for stopping the operation and the like (S4).

When there is no defect in the image recording apparatus 1 (S3: NO), according to the control program stored in the ROM 15, the control unit 11 executes external checks whether another apparatus is connected to the interface unit 14 or another apparatus normally operates (S5). Then, according to the control program stored in the ROM 15, the control unit 11 determines whether the normally operating relay apparatus 2 is connected to the interface unit 14 or not with reference to a result of the external checks (S6), and when the relay apparatus 2 is not connected (S6: NO), the control unit 11 terminates the process. When the relay apparatus 2 is connected (S6: YES), according to the control program stored in the ROM 15, the control unit 11 transmits the unique information of the image recording apparatus 1 stored in the managing unit 16 from the interface unit 14 to the relay apparatus 2 (S7).

The relay apparatus 2 receives the unique information transmitted from the image recording apparatus 1 by the interface unit 26 (S8). According to the control program stored in the ROM 23, the CPU 21 of the relay apparatus 2 determines whether the storage unit 24 has already stored the unique information or not (S9). When the storage unit 24 has not stored the unique information yet (S9: NO), according to the control program stored in the ROM 23, the CPU 21 stores the received unique information in the storage unit 24 (S13), and terminates the process.

When the storage unit 24 has already stored the unique information (S9: YES), according to the control program stored in the ROM 23, the CPU 21 compares the unique information received by the interface unit 26 with the unique information stored in the storage unit 24 (S10). Next, according to the control program stored in the ROM 23, the CPU 21 determines whether both unique information coincide with each other or not with reference to the comparison result (S11). When both the unique information coincide with each other (S11: YES), according to the control program stored in the ROM 23, the CPU 21 transmits the comparison result showing that both the unique information coincide with each other, from the communication unit 27 to the managing apparatus 31 through the communication network N (S12), stores the received unique information in the storage unit 24 (S13) and then terminates the process. When both the unique information do not coincide with each other at Step S12 (S11: NO), according to the control program stored in the ROM 23, the CPU 21 transmits the comparison result showing that both the unique information do not coincide with each other, from the communication unit 27 to the managing apparatus 31 through the communication network N (S14) and prohibits executing own process for relaying the image data to the image recording apparatus 1 (S15) and terminates the process.

In addition, although the process for transmitting the unique information is executed when the image recording apparatus 1 is turned on in the above process, the unique information may be transmitted when a state of the image recording apparatus 1 satisfies another predetermined condition, such as when a predetermined sleep state for saving a power is returned to an operable state, when a fact that the relay apparatus 2 is turned on is detected, or when a predetermined time comes. In addition, although the process for transmitting the comparison result of both the unique information to the managing apparatus 31 is consistently executed in the above process, the comparison result may not be transmitted when both the unique information coincide with each other and the information showing the mismatch of both the unique information may be transmitted only when both the unique information do not coincide with each other.

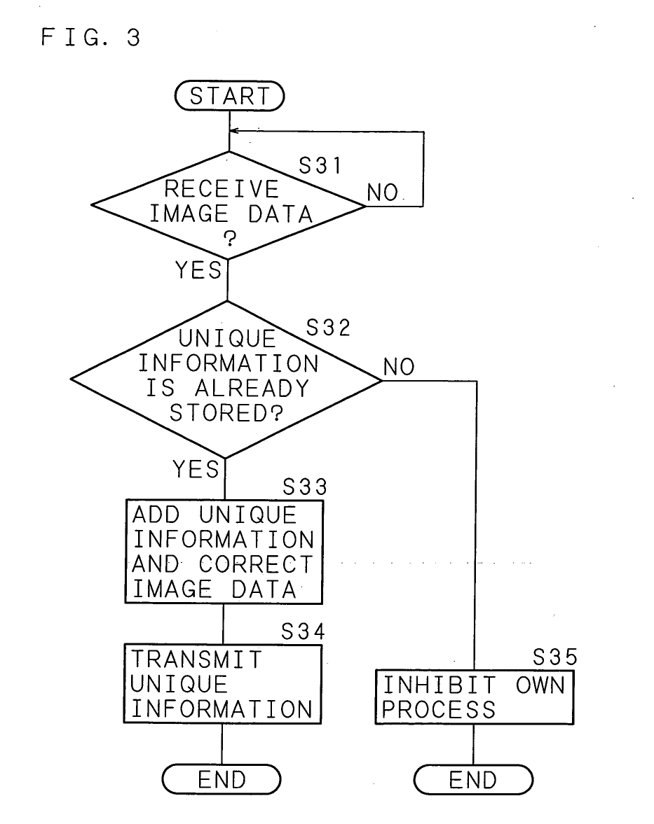

FIG. 3 is a flowchart showing procedures of the process executed by the relay apparatus 2 when the image recording system of the present invention records the image. The PC 32 transmits the image data formed by a software for image processing and the like to image recording apparatus 1 through the communication network N in order to record the image in the image recording apparatus 1. The CPU 21 of the relay apparatus 2 observes whether the image data transmitted from the PC 32 to the image recording apparatus 1 is received at the communication unit 27 (S31). When the image data is not received (S31: NO), the CPU 21 continues the observation of the reception.

When the image data is received (S31: YES), according to the control program stored in the ROM 23, the CPU 21 stores the received image data in the RAM 22 and determines whether the storage unit 24 stores the unique information of the image recording apparatus 1 or not (S32). When the storage unit 24 does not store the unique information (S32: NO), according to the control program stored in the ROM 23, the CPU 21 prohibits own process for relaying the image data to the image recording apparatus 1 (S35) and terminates the process.

When the storage unit 24 stores the unique information (S32: YES), according to the control program stored in the ROM 23, the CPU 21 executes the process for adding the unique information to the image data by incorporating a pattern which expresses the unique information with a color which is not likely to be visually observed, and the process for correcting the image data so that the color of the image displayed in the display apparatus of the PC 32 may approximate to the color of the image recorded by the image recording apparatus 1 as much as possible (S33). At this time, the CPU 21 corrects the image data so as to prevent deterioration of image quality caused by addition of the unique information as much as possible. Then, according to the control program stored in the ROM 23, the CPU 21 transmits the corrected image data to which the unique information is added from the interface unit 26 to the image recording apparatus 1 (S34) and terminates the process. In the image recording apparatus 1, the interface unit 14 receives the image data and the image forming unit 12 forms an image based on the received image data and outputs the recorded matter of image.

As described above, the image recording system of the present invention comprises the relay apparatus 2 which corrects the image data so that the color of the image displayed in the display apparatus of the PC 32 may approximate to the color of the image recorded by the image recording apparatus 1 as much as possible, between the PC 32 and the image recording apparatus 1. The relay apparatus 2 has a function of adding the unique information of the image recording apparatus 1 to the image data as well as the original function of correcting the image data and transmits the corrected image data to which the unique information is added to the image recording apparatus 1. Therefore, the image recording apparatus 1 does not need to comprise a circuit for executing a process for embedding the unique information in the image data, so that the cost of the image recording apparatus 1 can be lowered. In addition, since the relay apparatus 2 corrects the image data and adds the unique information, the image quality of the image can be prevented from deteriorating because of the addition of the unique information as much as possible.

In addition, according to the present invention, since the image recording apparatus 1 transmits the unique information to the relay apparatus 2, it is not necessary for the user to set the unique information manually. Thus, the leak of the unique information caused by the manual setting of the unique information will not happen.

In addition, according to the present invention, the unique information is transmitted from the image recording apparatus 1 to the relay apparatus 2 only when a predetermined condition in which the image can be recorded is satisfied, such as when the image recording apparatus 1 is turned on or when a fact that the relay apparatus 2 is turned on is detected. Therefore, since the unique information is not unnecessarily transmitted in a state the image is not recorded, the unique information can be prevented from leaking.

Furthermore, according to the present invention, the relay apparatus 2 stores the unique information of the image recording apparatus 1 and executes the process for adding the unique information to the image data, so that the unique information can be surely added to the image recorded by the image recording apparatus 1. Therefore, the image recording apparatus 1 can be surely specified from the recorded matter in which the image is recorded by using the image recording system of the present invention.

Still furthermore, according to the present invention, since the relay apparatus 2 compares the unique information transmitted from the image recording apparatus 1 with the previously stored unique information and when both the unique information do not coincides with each other, the relay apparatus 2 limits own process, that is, prohibits own process and the like based on the comparison result of both the unique information, so that the unique information can be prevented from being falsified or forged or illegal usage such as masquerading as the image recording apparatus 1 can be prevented. Therefore, the image recording apparatus 1 can be more surely specified from the recorded matter of the image.

In addition, according to the present invention, since the relay apparatus 2 informs the manager of the abnormality of the unique information by transmitting the comparison result of both the unique information to the managing apparatus 31, the illegal usage can be prevented from being continued.

Furthermore, according to the present invention, since the relay apparatus 2 limits the process, that is, prohibits the process and the like when the unique information of the image recording apparatus 1 cannot be recognized, such as when the unique information has not been stored yet, the image can be recorded only when the unique information can be added. Therefore, the image recording apparatus 1 can be more surely specified from the recorded matter of the image.

Although the example in which the image recording system of the present invention consists of the image recording apparatus 1 serving as the image recording unit and the relay apparatus 2 serving as the relay unit was shown in the above embodiment, the present invention is not limited to this, and the image recording system may be constituted by an image recording apparatus in which an image recording unit and a relay unit are integrally combined, or the image recording system may consist of a PC incorporating a relay unit inside and an image recording apparatus 1 serving as an image recording unit.

In addition, although one image recording apparatus 1 is connected to one relay apparatus 2 in the above embodiment, the present invention is not limited to this, and a plurality of image recording apparatus 1 may be connected to one relay apparatus 2. In this case, the relay apparatus 2 adds the unique information corresponding to the image recording apparatus 1 having an address of the image data transmitted from the PC 32, to the image data and transmits the image data to the image recording apparatus having that address.

Furthermore, although the storage unit 17 of the relay apparatus 2 stores the unique information and the unique information is added to the image data in the above embodiment, the present invention is not limited to this, and each time the relay apparatus receives the image data, it requires the unique information to the image recording apparatus and the unique information transmitted according to the requirement may be added to the image data.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. An image recording system including: an image recording unit for recording images based on image data; and a relay unit for relaying image data to be transmitted to said image recording unit and transmitting the image data to said image recording unit, wherein
said relay unit comprises:
unique information adding means for adding unique information of said image recording unit to the image data to be transmitted to said image recording unit; and
transmitting means for transmitting the image data, to which the unique information is added by said unique information adding means, to said image recording unit.

2. The image recording system as set forth in claim 1, wherein said relay unit comprises means for limiting an operation of itself when the unique information of said image recording unit cannot be recognized.

3. The image recording system as set forth in claim 1, wherein
said image recording unit comprises:
unique information storing means for storing the unique information; and
transmitting means for transmitting the unique information stored in said unique information storing means to said relay unit.

4. The image recording system as set forth in claim 3, wherein said relay unit further comprises storing means for storing the unique information transmitted from said image recording unit.

5. The image recording system as set forth in claim 4, wherein
said relay unit further comprises:
comparing means for comparing the unique information transmitted from said image recording unit with the unique information already stored in said storing means; and
means for limiting an operation of itself based on the comparison result by said comparing means.

6. The image recording system as set forth in claim 4, wherein
said relay unit further comprises:
comparing means for comparing the unique information transmitted from said image recording unit with the unique information already stored in said storing means; and
means for transmitting the comparison result by said comparing means to another predetermined apparatus.

7. The image recording system as set forth in claim 3, wherein
said image recording unit further comprises means for determining whether a state of said image recording unit satisfies a predetermined condition or not; and
when said means determines that the state of said image recording unit satisfies the predetermined condition, means for making said transmitting means transmit the unique information stored in said unique information storing means to said relay unit.

8. The image recording system as set forth in claim 7, wherein said relay unit further comprises storing means for storing the unique information transmitted from said image recording unit.

9. The image recording system as set forth in claim 8, wherein
said relay unit further comprises:
comparing means for comparing the unique information transmitted from said image recording unit with the unique information already stored in said storing means; and
means for limiting an operation of itself based on the comparison result by said comparing means.

10. The image recording system as set forth in claim 8, wherein
said relay unit further comprises:
comparing means for comparing the unique information transmitted from said image recording unit with the unique information already stored in said storing means; and
means for transmitting the comparison result by said comparing means to another predetermined apparatus.

11. An image recording system including: an image recording unit for recording images based on image data; and a relay unit for relaying image data to be transmitted to said image recording unit and transmitting the image data to said image recording unit, wherein
said relay unit comprises a control unit being capable of performing following operations of:
adding unique information of said image recording unit to the image data to be transmitted to said image recording unit; and
transmitting the image data, to which the unique information is added, to said image recording unit.

12. The image recording system as set forth in claim 11, wherein said control unit of said relay unit is further capable of performing following operation of limiting an operation of itself when the unique information of said image recording unit cannot be recognized.

13. The image recording system as set forth in claim 11, wherein
said image recording unit comprises:
a unique information storage unit for storing the unique information; and
a transmission unit for transmitting the unique information stored in said unique information storage unit, to said relay unit.

14. The image recording system as set forth in claim 13, wherein said relay unit further comprises a storage unit for storing the unique information transmitted from said image recording unit.

15. The image recording system as set forth in claim 14, wherein
said control unit of said relay unit is further capable of performing following operations of
comparing the unique information transmitted from said image recording unit with the unique information already stored in said storage unit; and
limiting an operation of itself based on the comparison result.

16. The image recording system as set forth in claim 14, wherein
said control unit of said relay unit is further capable of performing following operations of
comparing the unique information transmitted from said image recording unit with the unique information already stored in said storage unit; and
transmitting the comparison result to another predetermined apparatus.

17. The image recording system as set forth in claim 13, wherein
said image recording unit further comprises a control unit being capable of performing following operations of:
determining whether a state of said image recording unit satisfies a predetermined condition or not; and
making said transmission unit transmit the unique information stored in said unique information storage unit to said relay unit when it is determined that the state of said image recording unit satisfies the predetermined condition.

18. The image recording system as set forth in claim 17, wherein said relay unit further comprises a storage unit for storing the unique information transmitted from said image recording unit.

19. The image recording system as set forth in claim 18, wherein
said control unit of said relay unit is further capable of performing following operations of
comparing the unique information transmitted from said image recording unit with the unique information already stored in said storage unit; and
limiting an operation of itself based on the comparison result.

20. The image recording system as set forth in claim 18, wherein
said control unit of said relay unit is further capable of performing following operations of:
comparing the unique information transmitted from said image recording unit with the unique information already stored in said storage unit; and
transmitting the comparison result to another predetermined apparatus.

21. A relay apparatus which relays image data to an external image recording apparatus for recording an image based on the image data, comprising:
unique information adding means for adding unique information of said image recording apparatus to the image data to be transmitted to said image recording apparatus; and
means for transmitting the image data, to which the unique information is added by said unique information adding means, to said image recording apparatus.

22. The relay apparatus as set forth in claim 21, further comprising means for limiting an operation of itself when the unique information cannot be recognized.

23. The relay apparatus as set forth in claim 21, further comprising:
receiving means for receiving the unique information from said image recording unit; and
storing means for storing the unique information received by said receiving means.

24. The relay apparatus as set forth in claim 23, further comprising:
comparing means for comparing the unique information received by said receiving means with the unique information already stored in said storing means; and
means for limiting an operation of itself based on the comparison result by said comparing means.

25. The relay apparatus as set forth in claim 23, further comprising:
comparing means for comparing the unique information received by said receiving means with the unique information already stored in said storing means; and
means for transmitting the comparison result by said comparing means to another predetermined apparatus.

26. A relay apparatus which relays image data to an external image recording apparatus for recording an image based on the image data, comprising a control unit being capable of performing following operations of:
adding unique information of said image recording apparatus to the image data to be transmitted to said image recording apparatus; and
transmitting the image data, to which the unique information is added, to said image recording apparatus.

27. The relay apparatus as set forth in claim 26, wherein said control unit is further capable of performing operation of limiting an operation of itself when the unique information cannot be recognized.

28. The relay apparatus as set forth in claim 26, further comprising:
a reception unit for receiving the unique information from said image recording unit; and
a storage unit for storing the unique information received by said reception unit.

29. The relay apparatus as set forth in claim 26, wherein said control unit is further capable of performing following operations of:
comparing the unique information received by said reception unit with the unique information already stored in said storage unit; and
limiting an operation of itself based on the comparison result.

30. The relay apparatus as set forth in claim 26, wherein said control unit is further capable of performing following operations of:
comparing the unique information received by said reception unit with the unique information already stored in said storage unit; and
transmitting the comparison result to another predetermined apparatus.
